(19) United States
(12) Patent Application Publication
(10) Pub. No.: US 2026/0291203 A1
(43) Pub. Date: Sep. 24, 2026

(54) CONSTANT CURRENT STARTUP REGULATOR FOR FAULT MANAGED POWER

(71) Applicant: Cisco Technology, Inc., San Jose, CA (US)

(72) Inventors: Johnston Reid McGaughey, Austin, TX (US); Joel Richard Goergen, Soulsbyville, CA (US); Antonio Garza, Austin, TX (US); Matthew Stroud, Allen, TX (US)

(21) Appl. No.: 19/290,714

(22) Filed: Aug. 5, 2025

Related U.S. Application Data
(60) Provisional application No. 63/775,792, filed on Mar. 21, 2025.

(51) Int. Cl. H02H 1/00; H02H 3/027; H02H 3/08; H02H 3/32

(52) U.S. Cl. CPC H02H 1/0007; H02H 3/027; H02H 3/08; H02H 3/32

(57) ABSTRACT

A high voltage startup regulator for a power receiver that can safely start up after a power transmitter ramps up to potentially hazardous voltage levels. The startup regulator is connected between a send line and a return line over which pulse power is received at the power receiver. The pulse power includes alternating pulse-on times and pulse-off times, and the power transmitter performs safety checks for a fault during safety check intervals that correspond to the pulse-off times. The power receiver further includes a controller coupled to the startup regulator. The startup regulator is configured to provide a constant current at a predetermined level on the send line during the pulse-off times such that the power transmitter observes the constant current during the safety check intervals when there is no fault on the send line and return line.

### CROSS-REFERENCE TO RELATED APPLICATION

This application claims priority to U.S. Provisional Patent Application No. 63/775,792, filed Mar. 21, 2025, the entirety of which is incorporated herein by reference.

### TECHNICAL FIELD

The present disclosure relates to power delivery.

### BACKGROUND

In a fault managed power (FMP) system, a power transmitter performs safety checks while ramping the output voltage to potentially hazardous voltage levels. A power receiver that receives power from the power transmitter should not trip a safety check of the power transmitter while the power transmitter is ramping the voltage up to hazardous voltage levels.

### BRIEF DESCRIPTION OF THE DRAWINGS

FIG. 1 is a block diagram power delivery system comprising a power transmitter and a power receiver, where the power receiver includes a startup regulator configured to manage power while one or more components of the power receiver are starting up, according to an example embodiment.

FIG. 2A is a schematic diagram of the startup regulator in a power receiver, according to example embodiments.

FIG. 2B is a schematic diagram similar to FIG. 2A, but further showing a handover switch by which power to a controller in the power receiver is switched to load power, according to an example embodiment.

FIG. 2C is a schematic diagram similar to FIG. 2A, but further showing a rectifier circuit that may be deployed in the power receiver to enable the power receiver to receive alternating current (AC) power transmitted by the power transmitter, according to an example embodiment.

FIG. 3A is a timing diagram that depicts operation of the startup regulator in a power receiver, according to an example embodiment.

FIG. 3B is a timing diagram depicting how the startup regulator in a power receiver can be used to modulate a constant current observed by the power transmitter to communicate information to the power transmitter, according to an example embodiment.

FIG. 4 is a flow chart depicting a method for startup power regulation in a power receiver, according to an example embodiment.

FIG. 5 is a block diagram of a computing device that may include a power receiver, according to an example embodiment.

### DESCRIPTION OF EXAMPLE EMBODIMENTS

### Overview

Presented herein is a startup regulator for a power receiver that can safely start up after a power transmitter ramps up to potentially hazardous voltage levels. The startup regulator may also act as a low bit rate communication interface by modulating the current that can be observed by the power transmitter. In one example, the power transmitter slowly ramps from 0V to 400V without any dwell at a lower voltage. The power receiver draws a known current that does not vary and the current should be less than a predetermined level, such as 4 milliamps (mA). The power transmitter will continuously run safety checks and should always pass safety checks while the power receiver is starting up, and thereafter.

In one embodiment, an apparatus is provided including a startup regulator connected between a send line and a return line over which pulse power is received at a power receiver from a power transmitter. The pulse power includes alternating pulse-on times and pulse-off times, and the power transmitter performs safety checks for a fault during safety check intervals that correspond to the pulse-off times. The apparatus includes a controller coupled to the startup regulator. The startup regulator is configured to provide a constant current at a predetermined level on the send line during the pulse-off times such that the power transmitter observes the constant current during the safety check intervals when there is no fault on the send line and return line. The startup regulator couples power, derived from the constant current, to the controller to power the controller for a period of time.

In another embodiment, an apparatus is provided including a first power switch and a second power switch, the first power switch being coupled to a send line over which power is received from a power transmitter at a power receiver, and the second power switch being coupled to a return line in the power receiver. The apparatus further includes a controller configured to control the first power switch and the second power switch to open during power-off times and to close during power-on times, and a current source coupled to the send line and configured to output a constant current at a predetermined level on the send line during the power-off times such that the power transmitter observes the constant current during safety check intervals that correspond to the power-off times. The controller receives power, derived from the constant current, to power the controller for a period of time.

In another embodiment, a method is provided that is performed by a power receiver that receives power from a power transmitter. The method includes receiving pulse power from the power transmitter on a send line and a return line, the pulse power including alternating pulse-on times and pulse-off times. The power transmitter performs safety checks for a fault during safety check intervals that correspond to the pulse-off times. The method further includes providing, from a current source at the power receiver, a constant current at a predetermined level on the send line during the pulse-off times such that the power transmitter observes the constant current during the safety check intervals when there is no fault on the send line and return line, and coupling power, derived from the constant current, to a controller in the power receiver to power the controller for a period of time.

### Example Embodiments

A power delivery system includes a power transmitter, a power receiver and a power delivery conductor connecting the power transmitter to the power receiver. Fault detection schemes for the power delivery system may involve the power transmitter sending a pulse power waveform that has alternating periods of pulse-on times and pulse-off times. The pulse power delivery begins after the power transmitter and the power receiver complete an initialization phase when the power transmitter increases its voltage over the power delivery conductor up to a higher operating voltage level. Once at the higher operating voltage level, the power transmitter can sense current on the power delivery conductor during the pulse-off time intervals to perform a safety check (e.g., detect a fault). During the pulse-off time intervals, there are power switches at both the power transmitter and the power receiver that are controlled to disconnect from the power delivery conductor. This can create a problem because there are situations in which the power receiver needs to draw power when the power transmitter is transmitting power at a full (high voltage) power level, but the power receiver cannot put a load on the power delivery conductor during the safety checks. Consequently, if the power transmitter is checking current on the power delivery conductor during the pulse-off time intervals, the power receiver cannot draw current from the power delivery conductor during such times in order to become fully operational, which may be desired during some initial period of time after the power transmitter has been transmitting power at the full (higher voltage) power level.

In some fault detection architectures, there are known termination resistors on both the power transmitter side and the power receiver side of the power delivery conductor that the power transmitter ignores if it detects current that appears to be a nominal current through the known resistors.

Presented herein are techniques in which a constant current is presented on the power delivery conductor to the power transmitter during pulse-off times so that the power transmitter can perform its safety checks, but at the same time the power receiver is allowed to draw power from the power delivery conductor, which is desirable during some initial period of time after the power transmitter is transmitting power at its full (high voltage) level. This arrangement makes the current measurement performed by the power transmitter to be a constant current that is expected through a known termination resistance, and thus can be safely ignored if it is a low enough value and also does not vary significantly such that it would confuse the fault detection analysis of the power transmitter. In other words, when the power transmitter sees a constant current of a low enough level, the power transmitter can confidently determine there is no fault on the power delivery conductor between the power transmitter and the power receiver.

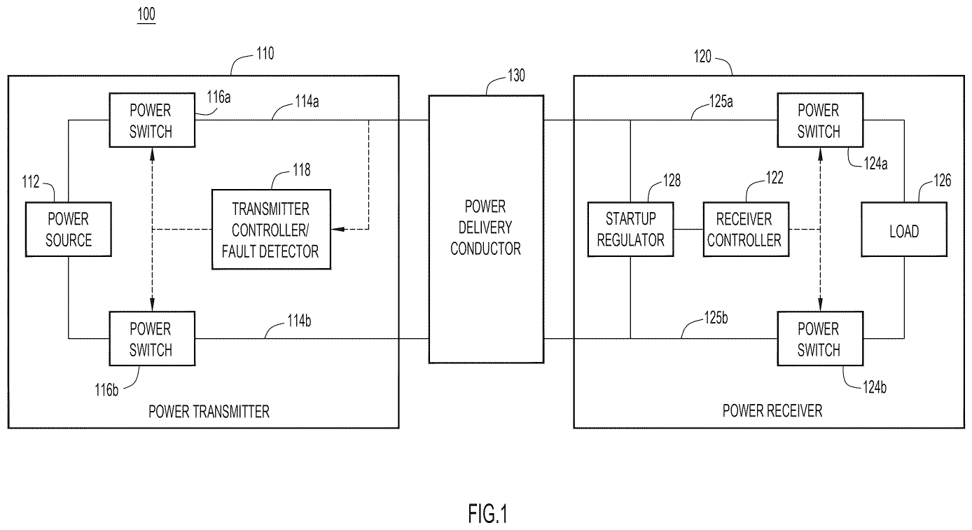

With reference first to FIG. 1, a power delivery system 100 is shown that includes a power transmitter 110 and a power receiver 120 connected to the power transmitter 110 via a power delivery conductor 130. The power delivery conductor 130 may comprise one or more conductors (wire pairs) capable of carrying/delivering power from the power source to a load. One example of a power delivery conductor is a cable with one or more wire pairs, and another example of a power delivery conductor is a bus bar. A bus bar is a metallic strip or bar, often housed inside switchgear, panel boards, and busway enclosures for local high current power distribution.

The power transmitter 110 may include a power source 112 that outputs power on a send line 114a, power switches 116a and 116b and a transmitter controller/fault detector 118. In some use cases, the power source 112 may be a direct current (DC) source that outputs a power level of, for example, 400 V DC or more. In other use cases, the power source 112 may be an alternating current (AC) source that outputs an AC power waveform. The power switch 116a is configured to connect the power source 112 to, and disconnect the power source 112 from, the send line 114a. There is a return line 114b back to the power source 112, and the power switch 116b (which is optional) is configured connect the power source 112 to, and disconnect the power source 112 from, the return line 114b. The opening and closing of the power switches 116a and 116b creates a pulse power waveform that includes time intervals when the power from the power transmitter onto the power delivery conductor 130 is on (referred to as power-on times or pulse-on times) and time intervals when the power from the power transmitter 110 is off (referred to as power-off or pulse-off times). The power-on times/pulse-on times and power-off times/pulse-off times terminology is intended to apply to both an AC power waveform as well as a DC power waveform.

The transmitter controller/fault detector 118 is connected to at least the send line 114a (and optionally to the return line 114b as well) to detect faults on the send line 114a and return line 114b and shut down power upon detecting a fault. The send line 114a and the return line 114b are connected to suitable conductors or conductive paths in the power delivery conductor 130. There are numerous fault detection techniques known in the art that the transmitter controller/fault detector 118 may employ, including those based on current measurements as well as voltage measurements.

The power receiver 120 includes a receiver controller 122, a power switch 124a that is connected to an input line 125a, a power switch 124b that is connected to a return line 125b, a load 126 that is connected to the input line 125a (which corresponds to the send line 114a) via power switch 124a and to the return line 125b via power switch 124b. A startup regulator 128 is connected to the input line 125a and to the return line 125b, as well as to the receiver controller 122. The load 126 may be any power consuming device to which the power receiver 120 provides power, such as wired or wireless transceiver, as an example.

The startup regulator 128 operates before the receiver controller 122 in the power receiver 120 is fully booted up and running. Since the startup regulator 128 operates during safety check time intervals, the current consumption is less than a predetermined amount, e.g., 4 milliamps (mA) and the current consumption is to be constant to avoid tripping a fault detection at the power transmitter.

While not specifically shown in FIG. 1, it is to be understood that there may be an in-band or an out-of-band mechanism to synchronize the opening and closing of the power switches 116a and 116b at the power transmitter 110 with the opening and closing of the power switches 124a and 124b at the power receiver 120 so that the power transmitter 110 performs safety checks during time intervals with the power switches 116a/116b are open and the power switches 124a/124b are open. In-band synchronization refers to a separate signal or characteristic of the pulse power waveform sent over the power delivery conductor to synchronize operation of the power switches 116a/116b at the power transmitter 110 with the operation of the power switches 124a/124b at the power receiver 120. Out-of-band synchronization refers to sending, over a communication path separate from the power delivery conductor, a signal used to synchronize operation of the power switches 116a/116b at the power transmitter 110 with the operation of the power switches 124a/124b at the power receiver 120. Numerous techniques for achieving synchronization are known in the art, and for simplicity, not presented herein.

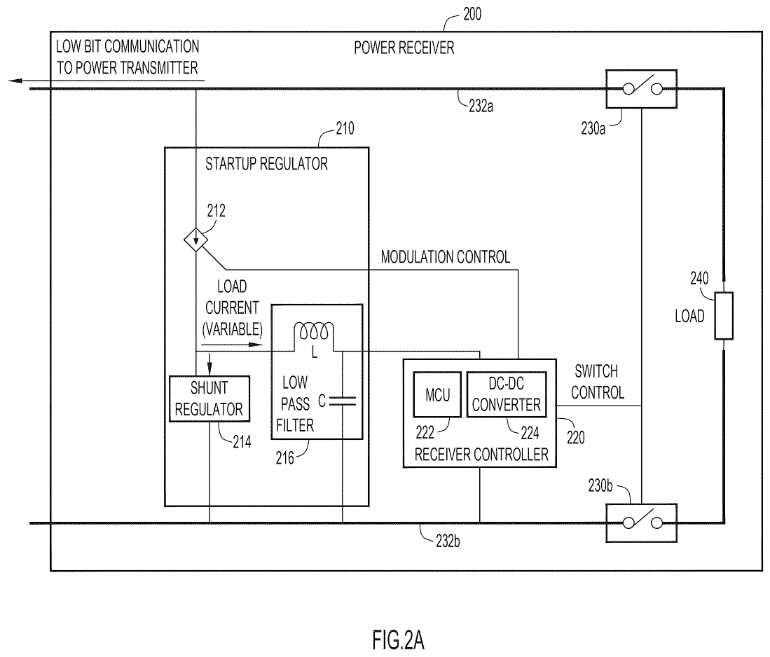

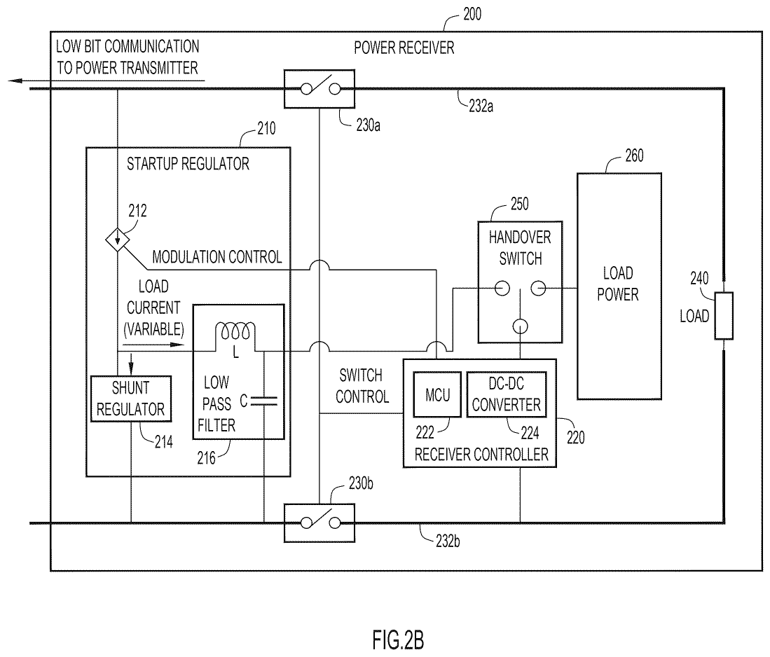

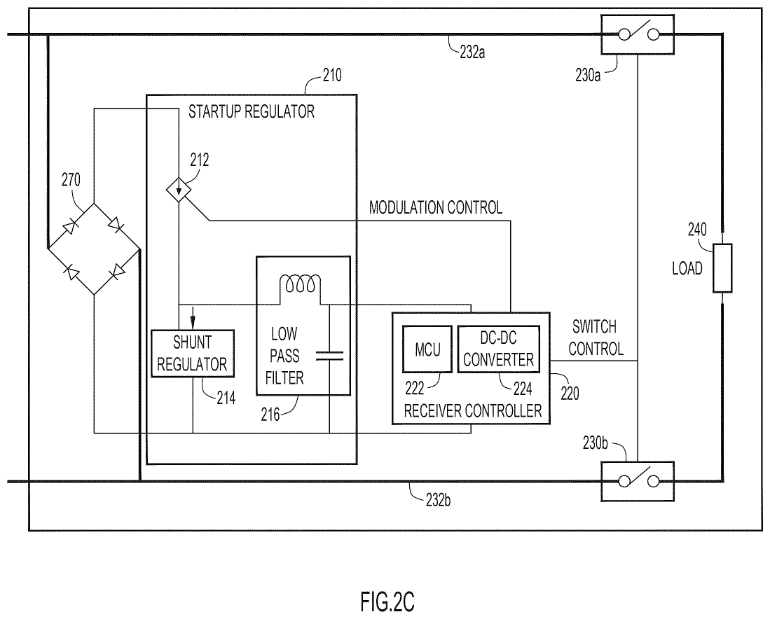

Reference is now made to FIG. 2A, which shows a power receiver 200 having a startup regulator 210 according to an example embodiment. The power receiver 200 further includes a receiver controller 220, power switch 230a connected in an input line 232a, power switch 230b connected in a return line 232b, and a load 240. The startup regulator 210 includes a current source 212, a shunt regulator 214, and an input low pass filter 216. In one example, the shunt regulator 214 is a Zener diode Z1, but there are other constant voltage shunt devices that may be used, such as a precision programmable reference (TL431). In one example, the low pass filter 216 is an inductor-capacitor (LC) filter, but it could also be a resistor-capacitor (RC) filter. The current source 212 outputs a constant current to ensure that as the line voltage changes (between the input line 232a which is an extension of the send line from the power transmitter and return line 232b), the load of the power receiver 200 will present as a constant current from the perspective of the power transmitter. The shunt regulator 214 masks the negative resistance characteristics of a Buck converter, which may be part of the receiver controller 220, as described further below. Said another way, the shunt regulator 214 provides a balancing load that keeps the current source 212 operating in a constant current region when the downstream load changes. The shunt regulator 214 consumes excess current from the current source 212 that is not consumed by the receiver controller 220.

The receiver controller 220 may include a microcontroller unit (MCU) 222 or other microprocessor or computing device, such as in an integrated circuit or a field programmable gate array (FPGA) form, as well as a step-down DC-DC converter 224. The DC-DC converter 224 may be a Buck converter, in one embodiment, that provides power for the MCU 222 to get the MCU 222 and thus the power receiver 200 fully up and running.

The current source 212 provides a constant current that exceeds a maximum load current of the DC-DC converter 224. In one example, the constant current is 4 milliamps (mA). The shunt regulator 214 consumes any excess current from the current source 212, and in this way, keeps the current from the current source at a constant level. The low pass filter 216 filters any high frequency transients in the load current, such as those that may be created by the DC-DC converter 224.

As mentioned above, the DC-DC converter 224 may be a Buck converter (or other similar device) that starts up and gets the power receiver going, but such that to the power transmitter observing current on the lines 232a and 232b, the current will appear to be a nominal current that flows through a fixed resistor (termination resistor). In this way, the power receiver 200 can obtain power during a time period without interfering with the safety checks that the power transmitter performs.

The current source 212 and the shunt regulator 214 (e.g., Zener diode) operate such that no matter how the downstream load varies, there will always be a constant and relatively low level of current (e.g., 4 mA) presented to the power transmitter on the lines 232a and 232b. For example, if the load current is 1 mA or 3 mA, the power transmitter will still see 4 mA. The shunt regulator 214 absorbs any extra current that is not being consumed by the DC-DC converter 224 of the receiver controller 220. If there is 4 mA coming from the current source 212, a variable amount of that is going to the DC-DC converter 224, and then 4 mA, less whatever the load current is, will go to the shunt regulator 214. Thus, there will always be 4 mA to the power delivery conductor (via lines 232a and 232b).

FIG. 2A also shows that the receiver controller 220 can modulate the current of the current source 212 to create a low bit rate communication channel back to the power transmitter during the safety check window. The power receiver 200 may use this low bit rate communication channel to communicate device classification or device type, device identifier, maximum load, power delivery conductor (cable) calibration data, or other useful information. The modulation used could include amplitude shift keying or other modulation schemes. The low bit rate communication channel is described further below.

FIG. 2B illustrates a block diagram of the power receiver 200 similar to that of FIG. 2B, but further including a handover switch 250. The handover switch 250 enables the receiver controller 220 to connect to the startup regulator 210 while the receiver controller 220 is starting up to normal operation. When the receiver controller 220 is booted up and fully operational, the receiver controller 220 may control the handover switch 250 to switch from the connection to the startup regulator 210 to instead obtain power from the load power 260. The load power 260 is power built up in the load 240 from power received via the input line 232a.

Turning now to FIG. 2C, a schematic diagram is shown of a power receiver 200 configured to receive alternating current (AC) power from a power transmitter. The power receiver 200 may include the same components as shown in FIGS. 2A and 2B, but further includes a rectifier circuit 270 connected between the input line 232a and the return line 232b. The rectifier circuit 270 may be a diode bridge that serves to rectify an AC power waveform when the power transmitter is configured to transmit AC power. Other types of rectifier circuits may be used. The configurations and operations of the power receiver 200 shown in FIG. 2C are otherwise the same as those described in connection with FIGS. 2A and 2B. The power transmitter and the power receiver will interrupt the AC power waveform (using the power switches) in order to perform safety checks in the same manner as the power transmitter and power receiver do for the DC pulse power waveform.

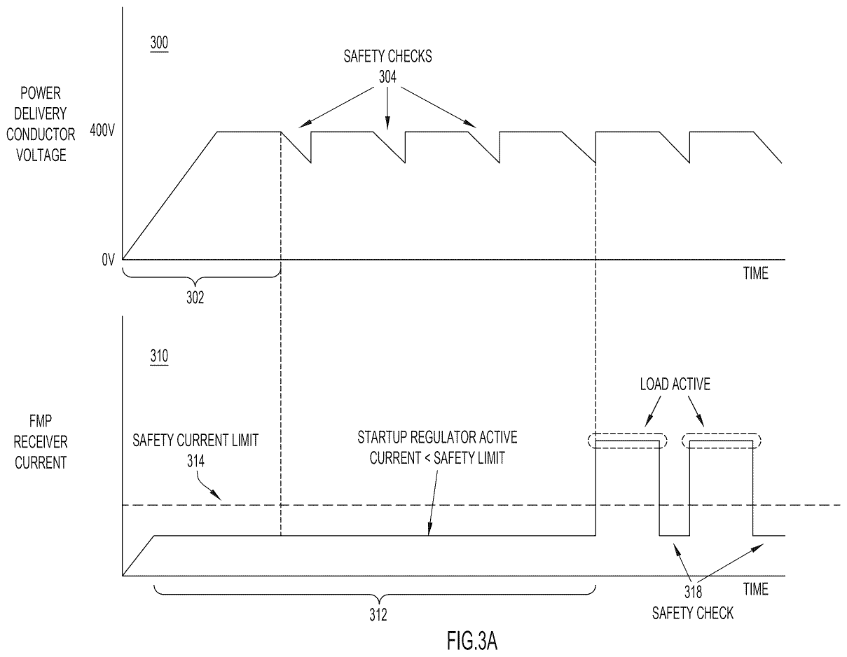

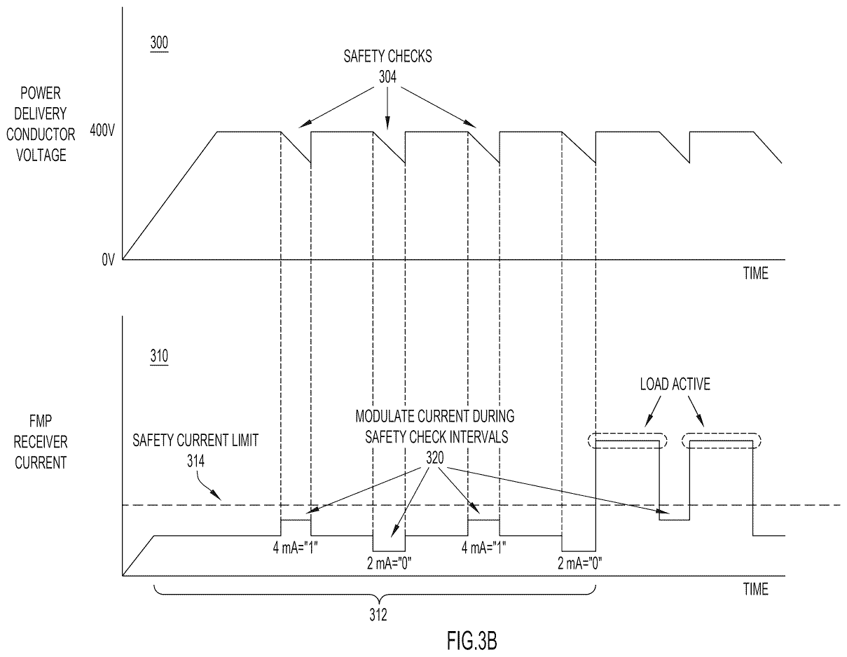

FIG. 3A shows a timing diagram depicting operation of the startup regulator by which the power receiver runs until the load can be enabled at a later time. FIG. 3A shows a plot 300 of voltage versus time on the power delivery conductor and a corresponding plot 310 of power receiver current versus time. The plots 300 and 310 are aligned with each other as shown. Reference is also made to FIGS. 1, 2A and 2B for purposes of the description of FIG. 3A.

The plot 300 at the top of FIG. 3A shows voltage over time on the power delivery conductor. There is an initial time interval 302 when the power transmitter turns on and begins applying power to the power delivery conductor; the voltage increases up to a desired high voltage level, e.g., 400 V, as an example. After reaching the desired high voltage level, the power transmitter begins periodic disconnects of power (pulse-off time intervals). The power transmitter performs safety checks during the safety check intervals 304 to detect presence of a fault on the power delivery conductor.

As shown by the plot 310, the current in the power receiver increases and there is a time interval 312, after the power on the power delivery conductor has reached or is close to reaching the desired high voltage level, during which the startup regulator is active in the power receiver and provides a moderate level of current to enable the receiver controller (the MCU 222 in the receiver controller 220 in particular) to boot up and become fully operational. The current, provided by the current source 212 shown in FIGS. 2A and 2B, is constant and at a level that is sufficient to enable the receiver controller 220 to boot up, but is also lower than a safety current limit 314 (also referred to as a safety check threshold) to avoid triggering detection of a fault by the power transmitter. In other words, the current output by the current source 212 is not high enough to exceed the safety current limit 314 that the power transmitter could interpret as a fault, but is sufficient enough to allow the MCU 222 of the receiver controller 220 to become operational. At the expiration of the time interval 312 (by which the receiver controller 220 is fully operational), the load at the power receiver can be fully active and accepting power, as shown at reference numeral 316. The power receiver will still disconnect power during the safety check intervals, as shown at reference numeral 318.

Turning now to FIG. 3B, with continued reference to FIGS. 1, 2A and 2B, a timing diagram is shown, similar to that of FIG. 3A, but further illustrating how the power receiver may modulate current to communicate information to the power transmitter. The modulation of the current may involve changing a level of the current output by the current source 212 from one pulse-off time interval to the next pulse-off time interval such that the different levels of the current during the successive pulse-off time (safety check) intervals represent different values of one or more bits, for example.

During the startup time interval 312, the receiver controller 220 may modulate the current output by the current source 212 during the safety check intervals 304 to communicate information back to the power transmitter. While operating off the startup regulator 210, the receiver controller 220 can control the current source 212 to modify the current level during the safety check time intervals, as shown at 320, but still keep the current less than the safety current limit 314. During safety check intervals 304, the power transmitter detects the current presented by the power receiver. For example, the receiver controller 220 may control the current source 212 to output 2 mA (signaling a logic “0”) during one safety check interval, and may control the current source 212 to output 4 mA (signaling a logic “1”) during a next safety check interval. This is depicted as such in FIG. 3B. Thus, a binary pattern with any number of symbols and/or modulation options may be transmitted to the power transmitter, with a current level during each safety check interval signaling values of one or more bits. The power transmitter would be configured to interpret detecting 4 mA as a logic “1” and detecting 2 mA as a logic “0” in the example above.

The current that is modulated during the safety check interval still has to be below some safety threshold limit, such as 30 mA. For example, 4 mA is chosen as a maximum level of the current source 212, which is much less, with significant margin, than the safety threshold limit. In other words, 4 mA, for example, is an amount of current that the power receiver may consume during a power-off time interval so as not to unintentionally be interpreted as a fault by the power transmitter.

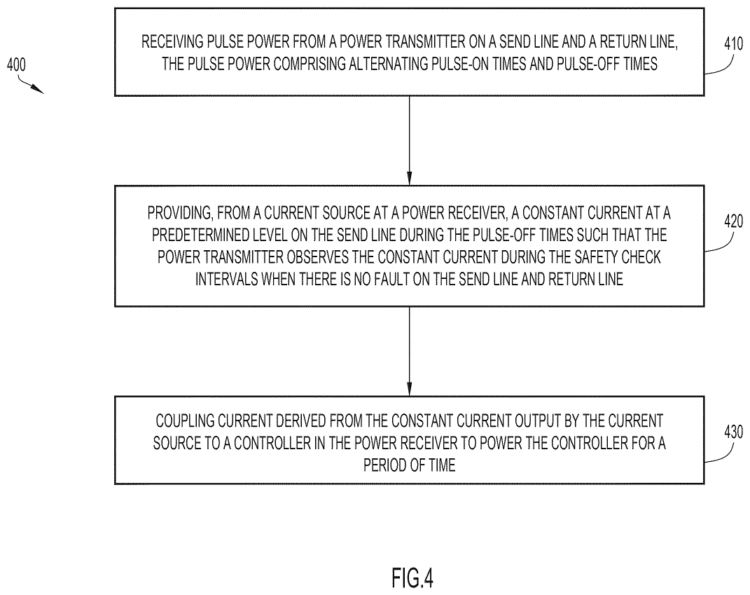

Reference is now made to FIG. 4. FIG. 4 illustrates a flow chart depicting a method 400 according to an example embodiment. The method 400 is performed by a power receiver that receives power from a power transmitter. At step 410, the method involves receiving pulse power from the power transmitter on a send line and a return line, the pulse power comprising alternating pulse-on times and pulse-off times. The power transmitter performs a safety check for a fault during safety check intervals that correspond to the pulse-off times. In other words, the safety check intervals are aligned with the pulse-off times.

At step 420, the method 400 involves providing, from a current source at the power receiver, a constant current at a predetermined level on the send line during the pulse-off times such that the power transmitter observes the constant current during the safety check intervals when there is no fault on the send line and return line. As explained above, the constant current is at a level low enough not to trip a safety threshold of the safety check performed by the power transmitter.

At step 430, the method 400 involves coupling power, derived from the constant current output by the current source, to a controller in the power receiver to power the controller for a period of time.

As explained above in connection with FIGS. 2B and 3A, the method 400 may further involve, after the period of time, decoupling to the controller the power derived from the constant current output by the current source, and coupling the controller to load power obtained by the power receiver.

The method 400 may further include shunting, with a shunt regulator coupled to the current source, excess current from the current source that is not consumed by the controller.

Further still, the method 400 may further include controlling the current source, with the controller coupled to the current source, to modulate an output of the current source during the safety check time intervals to communicate information to the power transmitter.

In summary, a startup regulator is provided for a power receiver that can safely start up after the power transmitter ramps up to potentially hazardous voltage levels. The startup regulator may also act as a low bit rate communication interface by modulating the current of a current source.

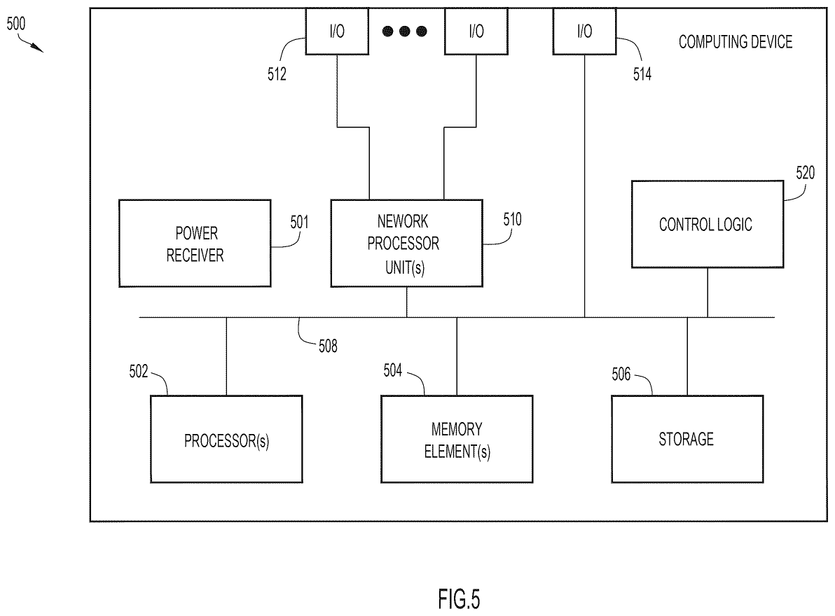

Referring to FIG. 5, FIG. 5 illustrates a hardware block diagram of a computing device 500 that may include a power receiver 501 that is implemented according to the embodiments depicted in FIGS. 1, 2A, 2B, 3A, 3B and 4. The computing device may be a component, such as a router, switch, gateway, load balancer, block of computing units (e.g., for various computing applications, such as artificial intelligence).

In at least one embodiment, the computing device 500 may be any apparatus that may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein. The various components of the computing device 500, other than the power receiver 501, may be viewed as one or more loads to the power receiver 501.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

To the extent that embodiments presented herein relate to the storage of data, the embodiments may employ any number of any conventional or other databases, data stores or storage structures (e.g., files, databases, data structures, data or other repositories, etc.) to store information.

In some aspects, the techniques described herein relate to an apparatus including: a startup regulator connected between a send line and a return line over which pulse power is received at a power receiver from a power transmitter, the pulse power including alternating pulse-on times and pulse-off times, the power transmitter performing safety checks for a fault during safety check intervals that correspond to the pulse-off times; and a controller coupled to the startup regulator; wherein the startup regulator is configured to provide a constant current at a predetermined level on the send line during the pulse-off times such that the power transmitter observes the constant current during the safety check intervals when there is no fault on the send line and return line, and wherein the startup regulator couples power, derived from the constant current, to the controller to power the controller for a period of time.

In some aspects, the techniques described herein relate to an apparatus, wherein the startup regulator includes: a current source configured to connect to the send line and to output the constant current at the predetermined level; and a shunt regulator configured to connect between the current source and the return line, the shunt regulator configured to consume excess current from the current source that is not consumed by the controller.

In some aspects, the techniques described herein relate to an apparatus, wherein the controller is configured to control the current source to modulate the constant current during the safety check intervals to communicate information to the power transmitter.

In some aspects, the techniques described herein relate to an apparatus, wherein the controller is configured to communicate information about the power receiver, the information including one or more of: device classification of the power receiver, device identifier of the power receiver, maximum load of the power receiver, and calibration data.

In some aspects, the techniques described herein relate to an apparatus, further including a low pass filter connected between the shunt regulator and the controller.

In some aspects, the techniques described herein relate to an apparatus, further including: a first power switch coupled to the send line; and a second power switch coupled to the return line, wherein the controller is configured to control the first power switch and the second power switch to close during the pulse-on times and to open during the pulse-off times.

In some aspects, the techniques described herein relate to an apparatus, wherein the startup regulator is configured to present the constant current at a level low enough not to trip a safety threshold of the safety checks performed by the power transmitter.

In some aspects, the techniques described herein relate to an apparatus, further including: a switch connected to the controller and the startup regulator, wherein after the period of time the switch is controlled to disconnect, from the controller, power derived from the constant current and to connect the controller to load power obtained by the power receiver.

In some aspects, the techniques described herein relate to an apparatus, wherein the controller includes a direct current-to-direct current (DC-DC) converter configured to output DC power.

In some aspects, the techniques described herein relate to an apparatus, wherein the controller further includes a microcontroller unit (MCU), and wherein the DC-DC converter provides the DC power to the MCU.

In some aspects, the techniques described herein relate to an apparatus, further including a rectifier coupled between the send line and the return line and configured to rectify an alternating current (AC) pulse power waveform to produce direct current (DC) power to the startup regulator.

In some aspects, the techniques described herein relate to an apparatus including: a first power switch and a second power switch, the first power switch coupled to a send line over which power is received from a power transmitter at a power receiver, and the second power switch coupled to a return line in the power receiver, a controller configured to control the first power switch and the second power switch to open during power-off times and to close during power-on times; and a current source coupled to the send line and configured to output a constant current at a predetermined level on the send line during the power-off times such that the power transmitter observes the constant current during safety check intervals that correspond to the power-off times, wherein the controller receives power, derived from the constant current, to power the controller for a period of time.

In some aspects, the techniques described herein relate to an apparatus, further including a shunt regulator configured to connect between the current source and the return line, the shunt regulator configured to consume excess current from the current source that is not consumed by the controller.

In some aspects, the techniques described herein relate to an apparatus, further including a low pass filter connected between the shunt regulator and the controller.

In some aspects, the techniques described herein relate to an apparatus, wherein the controller is configured to control the current source to modulate the constant current during the safety check intervals to communicate information to the power transmitter.

In some aspects, the techniques described herein relate to an apparatus, further including: a switch connected to the controller, wherein after the period of time the switch is controlled to disconnect, from the controller, power derived from the constant current and to connect the controller to load power obtained by the power receiver.

In some aspects, the techniques described herein relate to a method performed by a power receiver that receives power from a power transmitter, the method including: receiving pulse power from the power transmitter on a send line and a return line, the pulse power including alternating pulse-on times and pulse-off times, the power transmitter performing safety checks for a fault during safety check intervals that correspond to the pulse-off times; providing, from a current source at the power receiver, a constant current at a predetermined level on the send line during the pulse-off times such that the power transmitter observes the constant current during the safety check intervals when there is no fault on the send line and return line; and coupling power, derived from the constant current, to a controller in the power receiver to power the controller for a period of time.

In some aspects, the techniques described herein relate to a method, further including, after the period of time: decoupling to the controller the power derived from the constant current; and coupling the controller to load power obtained by the power receiver.

In some aspects, the techniques described herein relate to a method, further including: shunting, with a shunt regulator coupled to the current source, excess current from the current source that is not consumed by the controller.

In some aspects, the techniques described herein relate to a method, wherein the constant current is at a level low enough not to trip a safety threshold of the safety check performed by the power transmitter.

In some aspects, the techniques described herein relate to a method, further including controlling the current source, with the controller, to modulate an output of the current source during the safety check intervals to communicate information to the power transmitter.

In some aspects, the techniques described herein relate to a method, wherein the pulse power is a direct current (DC) power waveform or an alternating current (AC) power waveform.

In some aspects, the techniques presented herein relate to a system comprising a power transmitter and a power receiver. The power transmitter connects to the power receiver over a power delivery conductor to transmit power to the power receiver. The power transmitter transmits pulse power comprising alternating pulse-on times and pulse-off times, and performs safety checks for a fault during safety check intervals that correspond to the pulse-off times. The power receiver includes a startup regulator connected between a send line and a return line over which the pulse power is received from the power transmitter and a controller coupled to the startup regulator, wherein the startup regulator is configured to provide a constant current at a predetermined level on the send line during the pulse-off times such that the power transmitter observes the constant current during the safety check intervals when there is no fault on the send line and return line, and wherein the startup regulator couples power, derived from the constant current, to the controller to power the controller for a period of time.

In the system, wherein the startup regulator in the power receiver may include a current source configured to connect to the send line and to output the constant current at the predetermined level, and a shunt regulator configured to connect between the current source and the return line, the shunt regulator configured to consume excess current from the current source that is not consumed by the controller. The startup regulator may be configured to present the constant current at a level low enough not to trip a safety threshold of the safety checks performed by the power transmitter.

In the system, the controller at the power receiver may be configured to control the current source to modulate the constant current during the safety check intervals to communicate information to the power transmitter. For example, the controller is configured to communicate information about the power receiver, the information including one or more of: device classification of the power receiver, device identifier of the power receiver, maximum load of the power receiver, and calibration data.

In the system, the power receiver may further include a first power switch coupled to the send line and a second power switch coupled to the return line, wherein the controller is configured to control the first power switch and the second power switch to close during the pulse-on times and to open during the pulse-off times.

In the system, the power receiver may further include a hand-over switch connected to the controller and the startup regulator, wherein after the period of time the hand-over switch is controlled to disconnect, from the controller, power derived from the constant current and to connect the controller to load power obtained by the power receiver.

In the system, the controller of the power receiver may include a direct current-to-direct current (DC-DC) converter configured to output DC power. The controller may further include a microcontroller unit (MCU), and wherein the DC-DC converter provides the DC power to the MCU.

In the system, the power receiver may further include a rectifier coupled between the send line and the return line and configured to rectify an alternating current (AC) pulse power waveform to produce direct current (DC) power to the startup regulator.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure are described with more particular reference to the accompanying figures above.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.”

What is claimed is:

1. An apparatus comprising:
a startup regulator connected between a send line and a return line over which pulse power is received at a power receiver from a power transmitter, the pulse power comprising alternating pulse-on times and pulse-off times, the power transmitter performing safety checks for a fault during safety check intervals that correspond to the pulse-off times; and
a controller coupled to the startup regulator;
wherein the startup regulator is configured to provide a constant current at a predetermined level on the send line during the pulse-off times such that the power transmitter observes the constant current during the safety check intervals when there is no fault on the send line and return line, and wherein the startup regulator couples power, derived from the constant current, to the controller to power the controller for a period of time.

2. The apparatus of claim 1, wherein the startup regulator comprises:
a current source configured to connect to the send line and to output the constant current at the predetermined level; and
a shunt regulator configured to connect between the current source and the return line, the shunt regulator configured to consume excess current from the current source that is not consumed by the controller.

3. The apparatus of claim 2, wherein the controller is configured to control the current source to modulate the constant current during the safety check intervals to communicate information to the power transmitter.

4. The apparatus of claim 3, wherein the controller is configured to communicate information about the power receiver, the information including one or more of: device classification of the power receiver, device identifier of the power receiver, maximum load of the power receiver, and calibration data.

5. The apparatus of claim 2, further comprising a low pass filter connected between the shunt regulator and the controller.

6. The apparatus of claim 1, further comprising:
a first power switch coupled to the send line; and
a second power switch coupled to the return line,
wherein the controller is configured to control the first power switch and the second power switch to close during the pulse-on times and to open during the pulse-off times.

7. The apparatus of claim 1, wherein the startup regulator is configured to present the constant current at a level low enough not to trip a safety threshold of the safety checks performed by the power transmitter.

8. The apparatus of claim 1, further comprising:
a switch connected to the controller and the startup regulator, wherein after the period of time the switch is controlled to disconnect, from the controller, power derived from the constant current and to connect the controller to load power obtained by the power receiver.

9. The apparatus of claim 1, wherein the controller includes a direct current-to-direct current (DC-DC) converter configured to output DC power.

10. The apparatus of claim 9, wherein the controller further includes a microcontroller unit (MCU), and wherein the DC-DC converter provides the DC power to the MCU.

11. The apparatus of claim 1, further comprising a rectifier coupled between the send line and the return line and configured to rectify an alternating current (AC) pulse power waveform to produce direct current (DC) power to the startup regulator.

12. An apparatus comprising:
a first power switch and a second power switch, the first power switch coupled to a send line over which power is received from a power transmitter at a power receiver, and the second power switch coupled to a return line in the power receiver,
a controller configured to control the first power switch and the second power switch to open during power-off times and to close during power-on times; and
a current source coupled to the send line and configured to output a constant current at a predetermined level on the send line during the power-off times such that the power transmitter observes the constant current during safety check intervals that correspond to the power-off times,
wherein the controller receives power, derived from the constant current, to power the controller for a period of time.

13. The apparatus of claim 12, further comprising a shunt regulator configured to connect between the current source and the return line, the shunt regulator configured to consume excess current from the current source that is not consumed by the controller.

14. The apparatus of claim 13, further comprising a low pass filter connected between the shunt regulator and the controller.

15. The apparatus of claim 12, wherein the controller is configured to control the current source to modulate the constant current during the safety check intervals to communicate information to the power transmitter.

16. The apparatus of claim 12, further comprising:
a switch connected to the controller, wherein after the period of time the switch is controlled to disconnect, from the controller, power derived from the constant current and to connect the controller to load power obtained by the power receiver.

17. A method performed by a power receiver that receives power from a power transmitter, the method comprising:
receiving pulse power from the power transmitter on a send line and a return line, the pulse power comprising alternating pulse-on times and pulse-off times, the power transmitter performing a safety check for a fault during safety check intervals that correspond to the pulse-off times;
providing, from a current source at the power receiver, a constant current at a predetermined level on the send line during the pulse-off times such that the power transmitter observes the constant current during the safety check intervals when there is no fault on the send line and return line; and
coupling power, derived from the constant current, to a controller in the power receiver to power the controller for a period of time.

18. The method of claim 17, further comprising, after the period of time:
decoupling to the controller the power derived from the constant current; and
coupling the controller to load power obtained by the power receiver.

19. The method of claim 17, further comprising:
shunting, with a shunt regulator coupled to the current source, excess current from the current source that is not consumed by the controller.

20. The method of claim 17, wherein the constant current is at a level low enough not to trip a safety threshold of the safety check performed by the power transmitter.

21. The method of claim 17, further comprising controlling the current source, with the controller, to modulate an output of the current source during the safety check intervals to communicate information to the power transmitter.

22. The method of claim 17, wherein the pulse power is a direct current (DC) power waveform or an alternating current (AC) power waveform.
